(19) United States
(12) Patent Application Publication
(10) Pub. No.: US 2012/0205453 A1
(43) Pub. Date: Aug. 16, 2012

(54) INTERNATIONAL ALPHA-NUMERIC DEMOGRAPHIC IDENTITY CODE

(76) Inventor: Carlyle J. Rampersad, Seattle, WA (US)

(21) Appl. No.: 13/452,695

(22) Filed: Apr. 20, 2012

Related U.S. Application Data
(63) Continuation-in-part of application No. 12/938,528, filed on Nov. 3, 2010.
(60) Provisional application No. 61/258,426, filed on Nov. 5, 2009.

(51) Int. Cl. G06K 19/06; G06K 19/00

(52) U.S. Cl. 235/494; 235/487

(57) ABSTRACT

An apparatus for the creation, storage, management, manipulation and display of a de-identified unique global code for humans, containing both static and dynamic coded information, regardless of background or nationality. A registry web portal is programmed to display the code comprising a series of field code positions based on a series of field data forming an identity data set for a human. A sequence provider provides the registry with the code for display. Servers may retain additional data regarding the human segregated according to the code in a plurality of modules patterned after a structure and a function of the human neurological system.

### CROSS REFERENCE TO RELATED APPLICATION

This application is a Continuation-In-Part Application claiming priority under 35 USC 120 of U.S. patent application Ser. No. 12/938,528 filed Nov. 3, 2010, said application claiming priority under 35 USC 119(e) to Provisional Patent Application Ser. No. 61/258,426 filed Nov. 5, 2009, said applications hereby incorporated by reference in their entirety.

### FIELD OF THE INVENTION

The invention relates to de-identification of information regarding individuals to prevent the tracing of information using conventional methods, such as Passports, Driver's Licenses, Social Security Numbers and the like; namely, to an apparatus for the creation, encryption, storage, management, manipulation and display of an international code containing both static and dynamic coded information capable of unique identification of every individual on earth, and further capable of use in the storage and access of additional de-identified data regarding the individual, such as electronic medical records.

### The Invention

### Background of the Invention

Every service-based institution, service-based industry, and many governmental entities and non-government organizations have instituted a method of identifying persons, clients and/or the patients with whom they interact and serve. Some identification systems are limited to the use of the person's name; some include a person's birth date; others rely solely on Social Security numbers. The identification systems differ, are non-universal, are difficult if not impossible to render secure, and often cannot be shared from one entity to the next.

In the context of the medical field, each institution (such as a hospital) adopts its own internal patient identification system. These internalized identification systems are closed (used only within the entity's own computer records and databases) for control purposes and for compliance with privacy requirements imposed by federal laws and regulations, including the U.S. Health Insurance Portability and Accountability Act of 1996 (“HIPAA”). Medical institutions are plagued with the problem of how to share patient records between institutions without violating HIPAA. The lack of universal identification systems causes delays in transfer of patient identification and associated electronic records. As the global community becomes more and more transient, the medical profession is increasingly unable to identify persons transferred within the field and, as a result, lacks timely or full access to the patient's medical records. In addition, it has long been recognized that there is a correlation between a patient's ethnic background and the patient's susceptibility to disease (preconditioning). Typical identification systems provide no information about a person's ethnic background, and as inter-racial relations improve with trans-globe travel, ethnic backgrounds of successive generations are becoming increasingly difficult to trace.

While some countries have adopted nationwide identification systems, such as the Social Security number used in the United States, many countries have no such systems or are just in the process of adopting a system unique to that country. As a result, the ability to track persons within a country is increasing; however, the systems are not universal, cannot be shared easily among or between nations, and do not allow for accounting for human migration across country borders. Such migration is likely to increase rapidly with the onset of global climate change.

Even the existing advanced biometric code systems, such as fingerprint identification systems, do not take into account recent advances in DNA research. Biologists are finding that the DNA code has certain fixed or static qualities, as well as dynamic qualities relating to age, diet and environment. DNA is increasingly viewed as not only containing genetic code (static), but also containing epigenetic information (dynamic) specific to the person. Various biometric coding systems are in development, but the cost of such systems may preclude widespread use. In addition, privacy concerns over manipulation of biometric data (such as insurance company abuse of DNA data to deny certain types of insurance coverage, or fingerprint databases preventing travel to certain persons) are growing. As biometric systems are introduced, there will likely be a growing backlash to submission of body fluids, iris information, detailed fingerprints and the like.

Equally problematic is the epidemic in identify-theft arising from unauthorized use of existing code systems, such as Social Security Numbers issued by the U.S. government. Persons are now advised to provide a Social Security Number only if absolutely necessary due to widespread fraud. The existing code systems have been “broken” and are on the brink of becoming obsolete. On the other hand, the foreseeable systems coming online involving biometric identification go too far in violating privacy.

Accordingly, there is an urgent, but as of yet unmet, need in the global community for a system to provide a unique identification code for every human on earth that may be securely generated, encrypted, and utilized universally regardless of language or location, that not only cannot be stolen for identity-theft purposes, but also does not pose privacy concerns that might prohibit adoption and use, that is sufficiently de-identified and encrypted, but which also is demographic in nature, and is generated through a secure yet easily-accessible method regardless of location on earth.

### SUMMARY OF THE INVENTION

The inventive International Alpha-Numeric Demographic Identity Code provides an apparatus for the creation, storage, management, manipulation and display of a de-identified unique global code for every living (and deceased where desired) human on the earth.

The apparatus comprises a registry web portal programmed to display the code comprising a series of field code positions based on a series of field data forming an identity data set for a human. A sequence provider is programmed to assign a unique data key, encrypt and segregate each of the field data across a plurality of servers. The registry is programmed to send an encrypted request to the sequence provider, the request comprising at least one of the field data. The sequence provider is programmed to decrypt the request and determine a field code position for each of the field data. The sequence provider translates and assigns the field data to the field code positions. The sequence provider then provides the registry with the code for display.

The identity data set and corresponding field codes may represent both static (unchanging) information about the human and dynamic (changing) information to provide a more accurate, unique, complete and secure code.

The servers may further retain additional data regarding the human segregated according to the code in a plurality of modules patterned after a structure and a function of a human neurological system. For example, electronic medical records regarding the human may be stored and segregated according to the code in a plurality of modules in operative communication analogous to a left hemisphere and a right hemisphere of a human brain. Electronic medical records and a set of real-time physiological data for the human may be segregated according to the code in a plurality of modules, with the modules accessed for an analysis of a health condition for the human upon an amount of data within the modules reaching a specified threshold.

The invention further includes a computer implemented method of generating and displaying the de-identified unique global codes, and a non-transitory computer readable storage media containing a program to generate and display the codes.

### BRIEF DESCRIPTION OF THE DRAWINGS

The invention is described in more detail with reference to the attached drawings, in which:

FIG. 1 is a global map showing International Civil Aviation Organization country codes;

FIGS. 2 through 11 are pictorial representations of fictional persons with an exemplary assigned code represented alpha-numerically and as a two-dimensional bar code, according to the invention;

FIGS. 12 through 14 are block diagrams of an exemplary method for generating, saving, retrieving and reconstructing the code in a medical setting, according to the invention;

FIG. 15 is a block diagram of an exemplary method of storing electronic medical records data in association with a code, according to the invention; and,

FIG. 16 is a diagram of the left and right brain hemispheres as represented by the exemplary method of storing electronic medical records shown in FIG. 15.

### DETAILED DESCRIPTION

The following detailed description illustrates the invention by way of example, not by way of limitation of the scope, equivalents or principles of the invention. This description describes several embodiments, adaptations, variations, alternatives and uses of the invention.

In general terms, the inventive apparatus of this application may be utilized to de-identify, store and process data, including electronic medical records, through the use of an International Alpha-Numeric Demographic Identity Code, referred to herein as the “INDI” or “INDI code.” The de-identified data is stored in association with field codes making up the INDI code in three primary sectors analogous to the human brain: the neo-cortex, the limbic brain, and the spinal chord. The three database sectors mimic the human's neurological system and how it processes information, namely by creating unique short term and long term memory sets, generating responses using stored memory patterns, and developing new templates for new and modulated responses.

The apparatus provides unique means of de-identifying individuals so that information contained in their records (such as medical records) cannot be traced using conventional methods such as a Social Security Number, Birth Certificate, Passport, Driver's License, National Health Service Number, Travel Card, and the like.

The apparatus generates an alpha numeric code of field information unique to each human, and not relying on any biometric data, such as DNA. As data associated with an INDI code is updated, the INDI code may change. The dynamic nature of the INDI code adds to its cyber security.

The de-identified data may be utilized for non-invasive monitoring of individuals or entire specialized groups or nations, such as for research purposes and/or to observe patterns of disease and determine trends. Since the de-identified data is not identifiable with any other method used by state or local governments (Passport, Birth Certificate,

Social Security Number etc), governments, employers or insurance companies cannot use the information against an individual.

### A. Plurality of Alpha-Numeric Coded Sections

The first and vital step towards rendering all human-related records portable and interoperable within all current institutions throughout the world is to create an electronic identity for each individual that sufficiently de-identifies the individual, but which does not require use of biometric data raising associated privacy concerns.

In general terms, the INDI code is a de-identifying coded signature generated using both static and dynamic parameters specific to the particular person akin to the static nature of DNA code and the dynamic nature of the epigenetic influences on our genetic code. Portions of the INDI code are static (remain unchanged) while other portions are dynamic (change over time). Unchanging parameters include, but are not limited to, date of birth, given name at birth, country and place of birth, mother's maiden name, sexual identity, blood type, and ethnicity. Changing parameters include, but are not limited to, occupation and current country and place of residence. The INDI code combines the static and dynamic data into a single de-identifying coded signature.

The exemplary INDI codes disclosed herein consist of ten (10) distinct sections. Each section contains a type of information about the individual, from which field identifiers are generated to create an alpha-numeric sequence. Sections 1-8 consist of generally fixed or unchanging information about the individual; Sections 9-10 consist of current information about the person's environment which is subject to change. The exemplary sections are summarized as follows:

### Sections 1-8

### Section 1 [Initials of Current Name]

### Section 2 [Sexual Identity—Genotype]

### Section 3 [Date of Birth]

### Section 4 [Country and Place of Birth]

### Section 5 [Initials of Birth Mother's Maiden Name]

### Section 6 [Initials of Given Name at Birth]

Section 7 [Ethnic and Tribal Classification (verified by mDNA code-if known)]

### Section 8 [Blood Type]

### Sections 9-10

### Section 9 [Occupation]

### Section 10 [Bio-Status (Living/Deceased), Current Date/Date of Death, Current Residence City and Country/City and Country of Death]

### B. System for Coding within Each Section

Each field code within the INDI code is generated as follows:

### Section 1: Initials of Current Name

In Section 1 of the INDI code, the person's current name is coded by use of initials. The name is coded as follows: first initial of current surname, followed by first initial of the first name, followed by first initial of the middle name. If the person has no middle name, a zero is entered for that initial. For example, Jean Pierre Kelli is coded as KJP.

### Section 2: Sexual Identity

In Section 2 of the INDI code, the person's sexual identity is coded using “X” and/or “Y” to represent the sex chromosomes. A male is represented by the letters XY; a female is represented by the letters XX. For example, Jean Kelli (male) is coded as XY.

### Section 3: Date of Birth

In Section 3 of the INDI code, the person's date of birth is represented numerically by the month of birth, followed by the day of birth and the last three numbers of the year. The months are represented as follows: January is 01, February is 02, March is 03, and so on. The days of the month are represented numerically from 01 to 31. The year is represented by three numbers omitting the first number for a given year. For example, 1956 is 956, 2010 is 010, 2110 is 110, 2310 is 310. The date of birth of a fictitious person, Jean Kelli, born on Jan. 24, 1990, is displayed as: 0124990.

### Section 4: Country and Place of Birth

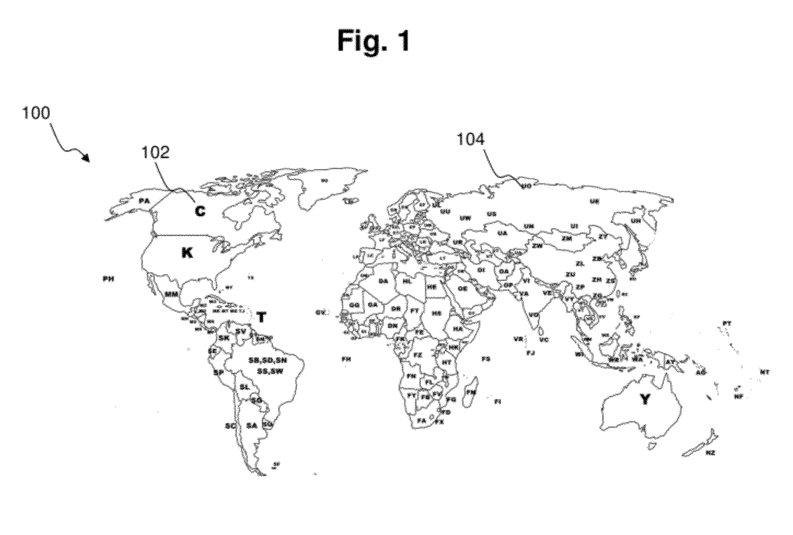

FIG. 1 is a global map showing the outline of countries 100 with unique letter-based International Civil Aviation Organization Aircraft Registration Codes 102/104 (“ICAO code”) assigned to each country. Referring to FIG. 1, the field codes for country of birth and place of birth are adopted from the current ICAO codes for country and airport locations.

As shown in FIG. 1, for regions with one country, a single letter is used 102 (for example, the letter “C” for Canada). For regions that contain more than one country, a second letter is added to the code 104. In general, the first letter is allocated by continent and represents a country or group of countries within that continent. The second letter generally represents a country within that region. An additional two codes (not shown) are used to identify each airport within each country. The exception to this rule is larger countries that have single-letter country codes, where the remaining three letters identify the airport.

ICAO codes are set by the International Civil Aviation Organization and are published in ICAO Document 7910: Location Indicators. The ICAO codes are used by air traffic control and airline operations for flight planning. They differ from IATA codes encountered by the general public which are used for airline timetables, reservations and baggage handling. For example, travelers who use London's Heathrow Airport will most likely be familiar with the IATA code: LHR. They are less likely, however, to be familiar with the ICAO code: EGLL. ICAO codes also are used to identify locations such as weather stations, International Flight Service Stations or Area Control Centers, whether or not they are located at airports.

ICAO codes provide geographical context unlike IATA codes. For example, with regard to Heathrow airport, if one knows that the ICAO code for Heathrow is EGLL, then one can deduce that the airport EGNH is located in the UK (it is Blackpool International Airport). On the other hand, knowing that the IATA code for Heathrow is LHR does not enable one to deduce the location of the airport LHV with any greater certainty (it is William T. Piper Memorial Airport in Pennsylvania in the United States).

In the contiguous United States and Canada, most, but not all, airports have been assigned three-letter IATA codes which are the same as their ICAO code without the leading K or C. e.g., YYC and CYYC (Calgary International Airport, Calgary, Alberta), IAD and KIAD (Washington Dulles International Airport, Chantilly, Va.). These codes are not to be confused with radio or television call signs, even though both countries use four-letter call signs starting with those letters. However, because Alaska, Hawaii and United States territories have their own 2-letter ICAO prefix, the situation there is similar to other smaller countries and the ICAO code of their airports is typically different from its corresponding 3-letter FAA/IATA identifier. For example, Hilo International Airport is coded PHTO versus ITO, and Juneau International Airport is coded PAJN versus JNU.

Smaller airports not designated under the ICAO code are assigned codes by each country's respective aviation agency. For example, in the United States, the Federal Aviation Administration has assigned the code F18 to an airport located in Cleburne, Tex. The code for the Cleburne Tex. airport under the present invention is KF18 (K for U.S.; F18 for Cleburne Tex.).

Sample ICAO country codes are as follows: A2—Botswana, A3—Tonga, A40—Oman, A5—Bhutan, A6—United Arab Emirates, A7—Qatar, A9—Bahrain, AP—Pakistan, B—China, BT—Taiwan, and BH—Hong Kong, China. Sample ICAO airport codes are as follows: EGKH—Lashenden/Headcorn Airport—Maidstone, England; EGKK (LGW) —London Gatwick Airport—London, England; EGKR (KRH) —Redhill Aerodrome—Redhill, England; EGLA—Bodmin Airfield—Bodmin, England; EGLC (LCY) —London City Airport—London, England.

Thus, for example, using the ICAO codes, the location of the town of Saint Pierre on the French island of Reunion in the Indian Ocean would be represented within the INDI code as follows: FR FMEP.

To determine which airport location code should be assigned for an individual's INDI code, the inventive system may further comprise an application program for: 1) entry of an individual's residence location data; 2) translation of that data into latitudinal and longitudinal coordinates (“Residence Coordinates”); 3) calculation comparing the Residence Coordinates against the Airport Center Coordinates; 4) determination of the Airport Center Coordinates in closest proximity to the Residence Coordinates; and, 5) calculation and display of the corresponding ICAO and/or country aviation agency code for the closest airport. Referring to Step 1 above, the residence location data entered may be in any suitable or desired form, including, without limitation, a location name (e.g., village name), a physical address, the name of the nearest location (village, town, city), and/or GPS coordinates for the individual's residence.

### Section 5: Initials of Birth Mother's Maiden Name

In Section 5 of the INDI code, information about the person's birth mother is coded in the form of initials of the birth mother's maiden name. The initials of a person's mother's maiden name are represented as follows: first letter of her maiden surname followed by first letter of her given first name, followed by the first letter of her given middle name. For example, Helene Marie Bouvier is represented as BHM.

### Section 6: Initials of Given Name at Birth

In Section 6 of the INDI code, the initials of a person's given name at birth are represented by the first letter of the person's surname followed by the first letter of the first name, followed by the first letter of the middle name.

### Section 7: Ethnic and Tribal Classifications

Section 7 of the INDI code contains coded information about the person's “ethnic” classification (static/DNA based), on the one hand, and a person's “tribal” classification (dynamic/environmental-based), on the other hand. Consequently, the classification comprises two sub-sections. The first sub-section represents the person's ethnic (genetic) background. The second sub-section represents the person's tribal (cultural) background. The two sub-sections combined assist in providing epigenetic information about the person, namely, the impact of a person's environment and culture as related to the person's genetic makeup.

The ethnic (genetic) classification is represented by a first alpha/numeric ethnic classification of the person's birth mother based on haplo genetics/mitochondrial maternal DNA, and a second alpha/numeric ethnic classification of the person's birth father based on the Y chromosomal haplo DNA line. The second sub-section for tribal (cultural) classification is represented by alpha/numeric codes reflecting cultures based upon the location of the person's upbringing and cultural background.

The ethnic and tribal classifications each comprise a two-position code that can be represented by two letters, two numbers, or a combination of a letter and a number. For the ethnic classification, the first position represents the first position of the mother's ethnic identity; the second position represents the first position of the father's ethnic identity. In a mixed race individual, the two positions are different letters/numbers; in an individual with parents of the same ethnic classification, the two positions are identical letters or numbers. Where the information is unknown for either parent, a zero is entered.

Ethnic (Genetic) Codes

The ethnic codes for the INDI code are based on six overall fractional groups derived from mitochondrial DNA in human migratory patterns originating in Africa, namely, Africa, Eastern Europe and the Mediterranean to Northern India, Europe, Asia, Pacific Islander/Australian (Oceania), and America. For each group, subgroups are identified by a two-position alpha and/or numeric code. Exemplary subgroups for Africa and Eastern Europe and Europe are represented as follows:

### Africa

AA—Central and Southern Africans (Peoples of Botswana, Zimbabwe, Lesotho, etc)

### ZZ—West and North West Africans

XX—East Africans (Tanzania, etc)
YY—Northeastern Africans (Somalia, Ethiopia, Eritrea, Parts of the Sudan etc)

### Eastern Europe and the Mediterranean to Northern India

### EE—North Africans and Middle Easterners (Egypt, Libya, Saudi Arabia, Gulf States)

FF—Peoples of (Persia) Iran, Afghanistan, Pakistan, and extending into Northern India

### WW—Turkish, Azerbijan, Turkmenstan

### BB—Peoples of Tajikistan, Kazakhstan, Uzbekistan etc.

### Europe

### 11—Italian

### 22—Anglo-Saxon (England, Wales)

### 33—Celtic (Ireland, Scotland)

### 44—Nordic (Norway, Sweden, Iceland)

### 55—Finnish (Finland, Lithuania, Estonia, Latvia)

66—Germanic Austrian, Danish, Dutch and the lower countries of Western Europe

### 77—French

### 88—Spanish, Portuguese

### 99—Basque

The first designation of the individual's ethnic classification code is comprised of the first letter or number of the mother's ethnic classification. The second designation is comprised of the first letter or number of the father's ethnic classification.

For example, assuming a person's mother is a combination of a North Eastern African (Somalia YY) mother and a European (French 77) father, the mother's ethnic code will be “Y” from the mother and “7” from the father, or “Y7”. If the person's father is English, Anglo-Saxon on both parents' side, his code is 22. The person's ethnic classification will be “Y2” —the first letter of his mother's code (“Y”) followed by the first number of his father's code (“2”).

As another example, the ethnic coding for a male individual of mixed parents (Mother-Thai—TT, Father-American of German Ancestry-66) is T6. If that individual were to marry an American of Anglo-Saxon/Norwegian heritage, whose code is 24, the ethnic code for the subsequent offspring is 2T—a combination of the first letter of the mother's ethnic classification (“2”) and the first letter of the father's ethnic classification (“T”). The code follows the mother's ethnic classification in the first position because of the significance of the maternal mitochondrial DNA in tracking identity.

While the current ethnic classification is coded based on maternal and paternal ethnic backgrounds, it should be understood that as DNA research continues, and DNA testing becomes more available, Section 7 of the INDI code may be expanded to accommodate additional and/or different types of data relating to ethnic origins.

Tribal (Cultural) Codes

The second sub-section of the Ethnic and Tribal Classification is a coded representation of the person's cultural upbringing and background (as opposed to the genetic background). Each Tribal Classification is a one to three letter code. A person may have a single Tribal Classification or multiple Tribal Classifications. The Tribal Classifications include a diaspora of the representative peoples on earth. Examples are as follows:

A—Abzinz—minority in Abkhazia, Karachay-Cherkessia and Adygeya of Russia

### AA—Abenaki—Native Americans of Quebec, Vermont, New Hampshire, Maine and Nova Scotia

AB—Abipones—an ethnic minority in Argentina
AC—Abkhaz—minority ethnic group in Georgia, Turkey, Russia and Abkhazia
AD—Aborigines—indigenous peoples of mainland Australia
ABJ—Ak Chin—Native American group now resident in Pinal County, Arizona on the Tohono O'odham Reservation

### Section 8: Blood Type

Section 8 of the INDI code contains coded information regarding the person's blood type. The blood types are represented as follows: A positive by the number 1, B positive by the number 2, AB positive by the number 3, O positive by the number 4, A negative by the number 5, B negative by the number 6, AB negative by the number 7, O negative by the number 8. If the blood type is unknown, the field is assigned the numeral zero. In the event new blood types or other blood identifiers are discovered through future research, Section 8 may be expanded to accommodate additional codes to represent the findings.

### Section 9: Occupation

Section 9 of the INDI code contains a code representing the person's current occupation. Occupation codes are assigned among 35 categories. The first position in the occupation code is a letter or number indicating the overall field of occupation. Examples are as follows: the letter “A” for arts and entertainment, including artists, actors, musicians, writers; the letter “B” for banking and finance related occupations; the letter “C” for management and administrative related occupations; the letter “D” for distribution, sales and purchasing related occupations; the letter “E” for education and research related occupations; and, the letter “F” for farming, fishing, ranching, and hunting related occupations.

The second and any additional positions of the occupation code constitute a letter or number representing a sub-field or field of specialty within the occupation. For example, under the occupation of Engineering (represented by the letter “N”), the sub-specialties include Aerospace A, Agricultural B, Automotive C, Biomedical D, Chemical E, and Civil F. Consequently, a person with the occupation code of “NA” would be an Aerospace Engineer; a person with the occupation code of “NE” would be a Chemical Engineer.

### Section 10: Bio-Status (Living/Deceased), Current Date/Date of Death, Current Residence City and Country/City and Country of Death

The final section of the INDI code provides coded information indicating whether the person is living or deceased. If living, the code “L” is assigned along with the current date in the same manner as for Section 3, supra. Following the date, the location of the person's current residence (city and country) is coded using the same ICAO codes as utilized for Section 4, supra.

Conversely, if the person is deceased, the code “D” is assigned along with the date of death (in the same manner as Section 3, supra), and the location (city and country) where the person died (in the same manner as Section 4, supra).

### C. Exemplary INDI Codes

For purposes of generating exemplary INDI codes, the following fictional persons are presented.

### Jean Pierre Kelli—Professional Canadian Skier

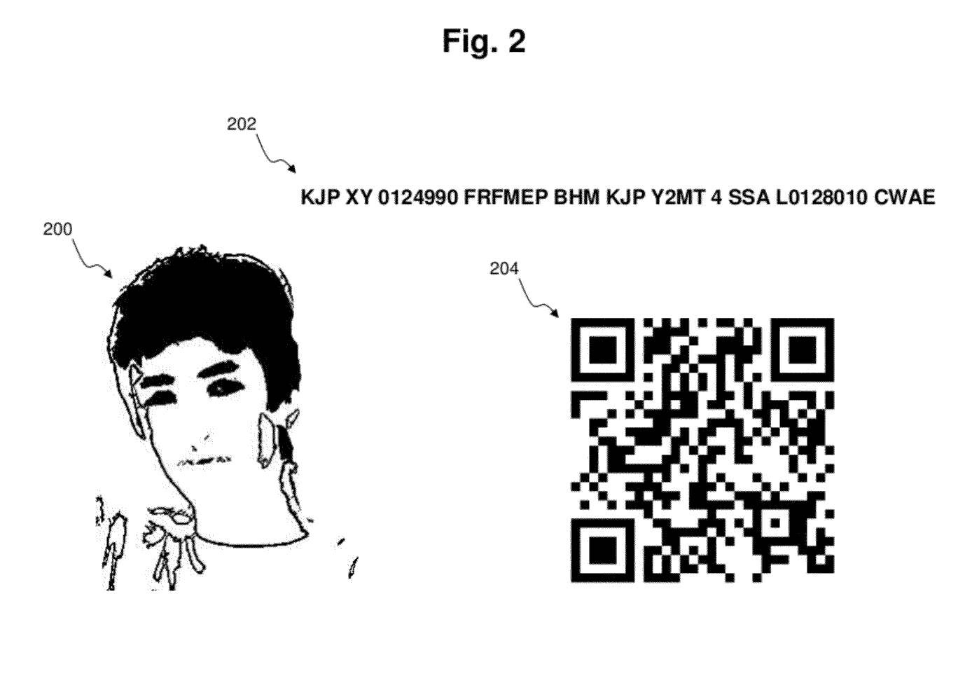

Referring to FIG. 2, a pictorial representation of the fictional Jean Pierre Kelli 200 is shown. Mr. Kelli 200 is a young man, born on Jan. 24, 1990 in the town of Saint Pierre on the French island of Reunion in the Indian Ocean, to Helene Marie Bouvier. His given name at birth is Jean Pierre Kelli. His mother, Helene, is of East African descent and belongs to the Malagasi tribe of Madagascar. Helene's mother was from Somalia and her father was from England and has an Anglo-Saxon ethnicity. Helene's husband (and the father of Jean Pierre) is from France, but his mother was from England. Jean Kelli has a common Blood type of O positive and currently lives in Whistler, British Columbia, Canada, where he is a professional skier.

Referring to FIG. 2, all of the above information is reflected in an INDI code 202 for this fictional person. The INDI code 202 is shown generated and displayed as a string of alpha-numeric letters and numbers.

Referring to the INDI code 202 shown in FIG. 2, and reading the code from left to right, each section contains coded information as follows. Section 1 contains the letters “KJP” for Mr. Kelli's current initials. Section 2 contains the letters “XY” for male genotype. Section 3 contains the numbers “0124990” representing a date of birth of Jan. 24, 1990. Section 4 contains the letters “FRFMEP” representing the ICAO code closest in proximity to his location of birth—Saint Pierre on Reunion Island. Section 5 contains the letters “BHM” for his mother's maiden name of Helene Marie Bouvier. Section 6 contains the letters “KJP” representing Mr. Kelli's initials at birth. Section 7 contains “Y2MT”. The combination “Y2” represents the first position of the ethnic classification of Mr. Kelli's mother (“Y”) and the first position of the ethnic classification of Mr. Kelli's father (“2”). The combination “MT” represents Mr. Kelli's cultural background of the Malagasi Tribe of Madagascar, his mother's tribe. Section 8 represents Mr. Kelli's blood type by the number “4” for O-positive. Section 9 represents Mr. Kelli's occupation by the letters “SSA” —the first letter “S” is for a sport-related occupation, the second letter “S” represents the sub-specialty of skiing; the third letter “A” represents a professional athlete. Section 10 contains the letter “L” for living, followed by the date the information was entered/last updated and the letters “CWAE” representing the ICAO code closest in proximity to Mr. Kelli's current residence, namely, Whistler, British Columbia, Canada.

Referring again to FIG. 2, the same information contained in the INDI 202 is shown coded for privacy in the form of a case sensitive two-dimensional barcode 204. Barcodes represent data in an optical, machine-readable format. Barcodes are typically linear or one-dimensional symbologies. However, barcodes may also take on the form of shapes, such as squares or hexagons. These two-dimensional or matrix symbologies are made of symbols rather than bars. The barcode 204 shown in FIG. 2 is a Quick Response (“QR”) Code readable by QR scanners, typically incorporated into mobile phones with a camera or smartphones. The code 204 comprises black shapes arranged in a square-shaped pattern on a white background. The coded information may be alpha-numeric or other types and forms of data.

Nelson Pachua Pivane—Hopi Indian

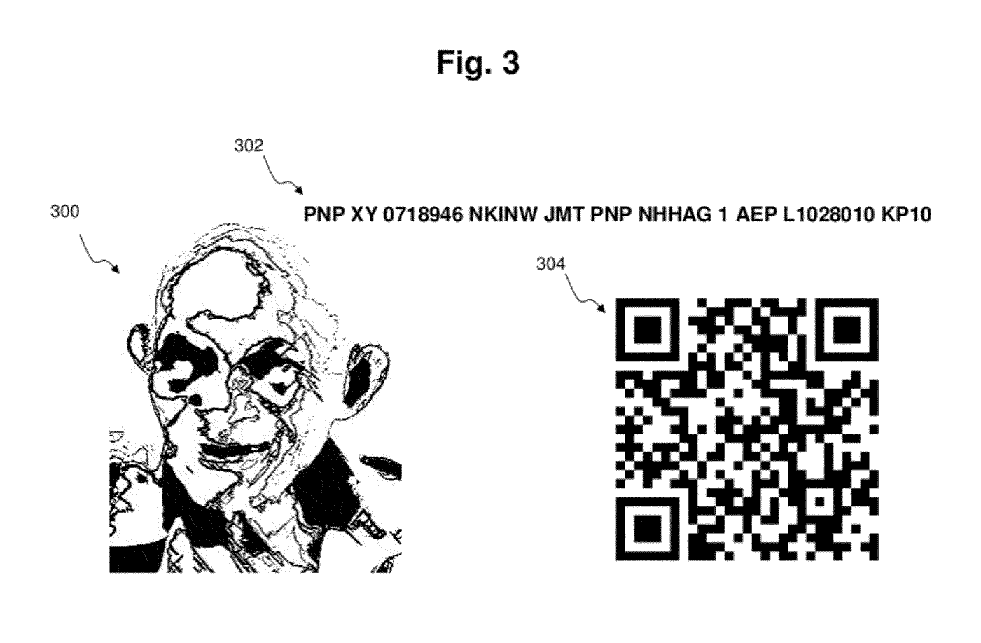

Referring to FIG. 3, an outline of the fictional Nelson Pachua Pivane 300 is shown. Mr. Pivane 300 was born on Jul. 18, 1946 in Winslow, Ariz., USA, to Mariam Tohopka James. His given name at birth was Nelson Pachua Pivane. His mother was a U.S. native Indian; his father was of mixed Hispanic descent. He was raised by his mother as a Hopi Indian of the southwest USA. His blood type is A positive. His occupation has been in the arts, entertainment, and education, most recently as a pottery instructor. Mr. Pivane currently lives in Kerns Canyon, Ariz. (USA).

Referring to FIG. 3, all of the above information is reflected in the INDI code for Mr. Pivane as shown both as a string of alpha-numeric letters and numbers 302 and as a two-dimensional barcode 304. Referring to FIG. 3, reading from left to right, the INDI code 302 contains coded information for each section as follows. Section 1 contains the letters “PNP” for Mr. Pivane's initials. Section 2 contains the letters “XY” for male genotype. Section 3 contains the numbers “0718946” representing a date of birth of Jul. 18, 1946. Section 4 contains the letters “NKINW” representing the ICAO code closest in proximity to his location of birth—Winslow, Ariz., USA. Section 5 contains the letters “JMT” for his mother's maiden name. Section 6 contains the letters “PNP” representing Mr. Pivane's initials at birth.

Section 7 contains “NH HAG”. The combination “NH” represents the first position of the ethnic classification of Mr. Pivane's mother (“N” from “NN” for native American indian) and the first position of the ethnic classification of Mr. Pivane's (“H” from “HH” for mixed Hispanic descent). The tribal code of “HAG” represents the Hopi Indian tribe of southwestern United States.

Section 8 represents Mr. Pivane's A positive blood type by the number “1”. Section 9 represents Mr. Pivane's occupation by the letters “AEP” —the first letter “A” is for an arts and entertainment-related occupation, the second letter “E” represents the sub-specialty of educator; the third letter “P” represents a pottery instructor. Section 10 contains the letter “L” for living, followed by the current date (Oct. 28, 2010) and the ICAO code of KP10 for his city and country of residence in Kerns Canyon, Ariz., United States.

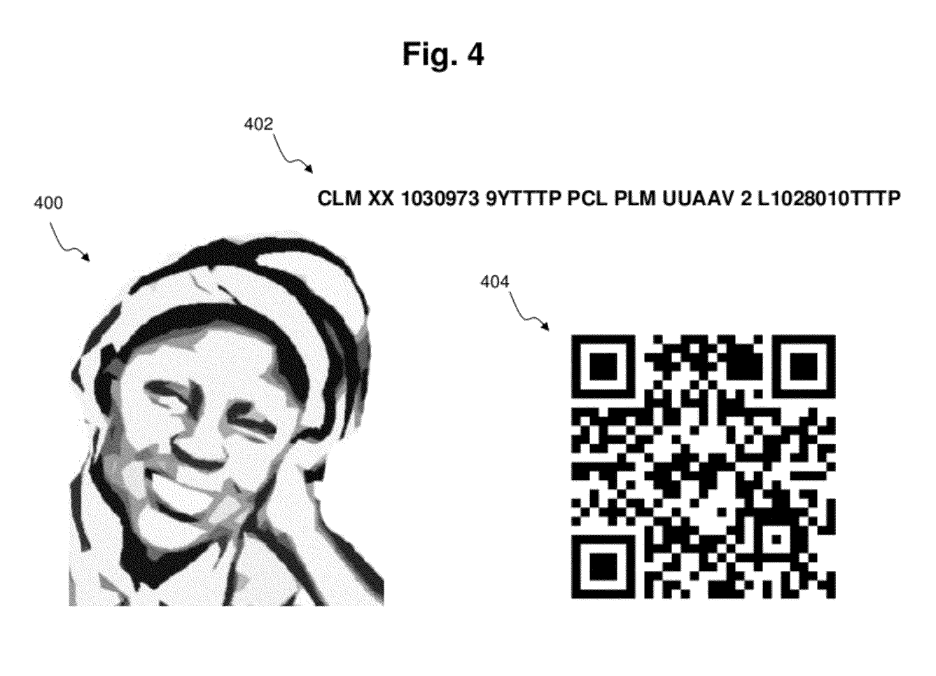

The global application of the INDI system and apparatus is apparent upon examination of other fictional persons as represented in FIGS. 4 through 11. The persons, along with their coded identity data, are summarized below.

Lorna May Cartwright—Afro-Caribbeanner

Referring to FIG. 4, the INDI code 402 and bar code 404 reflect the following identity data set for an Afro-Caribbean woman 400:

### Name: Lorna May Cartwright (CLM)

### Sex: Female (XX)

### Date of Birth: 30 Oct. 1973 (1030973)

### Country of Birth: Trinidad and Tobago (9Y)

### City of Birth: Spring Vale, Claxton Bay (TTTP)

### Mothers' Maiden Name: Charmaine Louise Penco (PCL)

### Given Name at Birth: Lorna May Penco (PLM)

Genetic Ethnic Classification—Genome Mother Afro Caribbean of Undetermined ancestry (UU))

### Father Afro Caribbean of Undetermined Ancestry (UU)=(UU)

### Cultural Ethnic Classification—Epi-Genome Afro Trinidadian (AAV)

### Blood Type: B Positive (2)

Job Classification Head Chef in a private hospital (HM2)

### Current Residence Current Date and Country and City (ICAO) Living (L) 28 Oct. 2010 St James Port of Spain, Trinidad (1028010TTTP)

Antonio Joseph Melchiorrie—Deceased Italian American

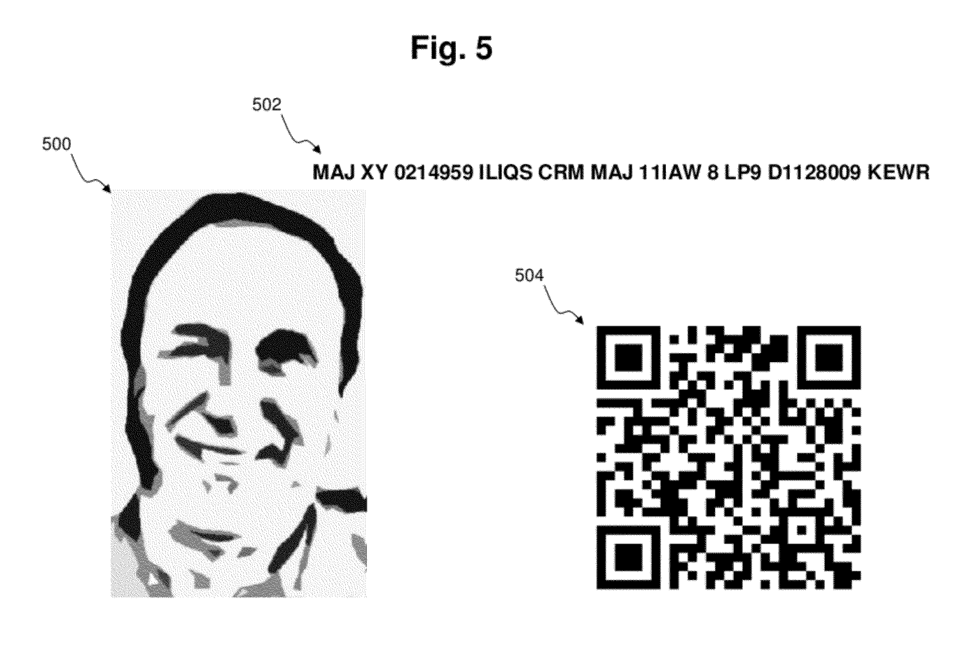

Referring to FIG. 5, the INDI code 502 and bar code 504 reflect the following identity data set for a deceased Italian American man 500:

### Name: Antonio Joseph Melchiorrie (MAJ)

### Sex: XY

### Date of Birth: Feb. 14, 1959 (0214959)

### Country of Birth: Italy (I)

### City of Birth: Siena in Tuscany (LIQS)

### Mothers' Maiden Name: Rosaria Marie Carrocia (CRM)

### Given Name at Birth: Antonio Joseph Melchiorrie (MAJ)

### Genetic Ethnic Classification—Genome: Mother Italian, Father Italian (11)

Cultural Ethnic Classification—Epi-Genome [Italian American] (lAW)

### Blood Type: O Negative (8)

### Job Classification Lawyer State (New Jersey)—Personal Injury Private Practice (LP9)

### Deceased (D) Date and Country and City 28 Nov. 2009, Newark, N.J. (1128009 KEWR)

Bashir Hassan Zafar—Iranian

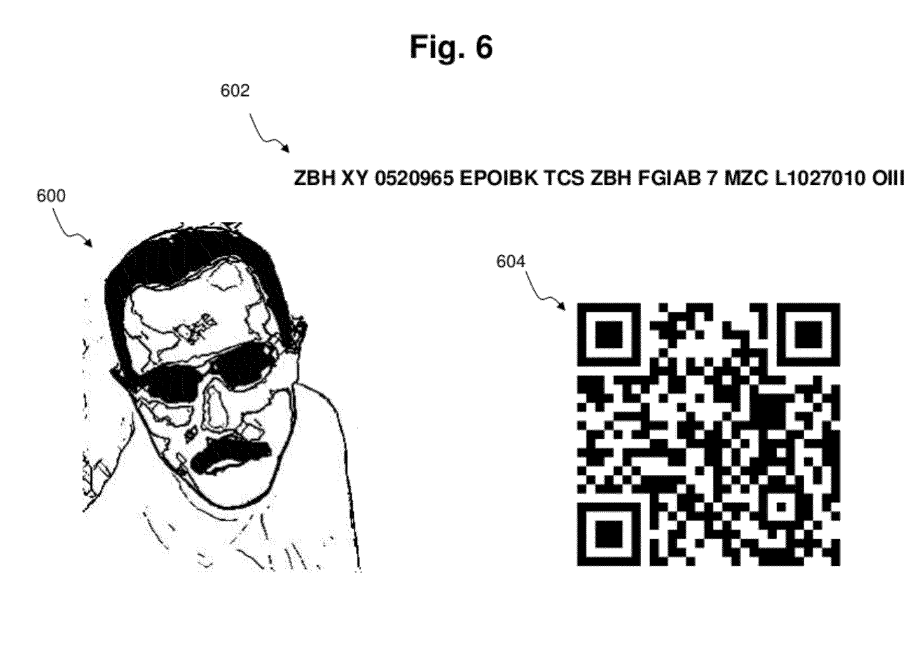

Referring to FIG. 6, the following identity data set for an Iranian male physician 600 is contained within the INDI code 602 and associated bar code 604:

### Name: Bashir Hassan Zafar (ZBH)

### Sex: Male (XY)

### Date of Birth; May 20, 1965

### Country of Birth: Iran (EP)

### City of Birth: Kish Island Persian Gulf (OIBK)

### Mothers' Maiden Name: Chehreh Sarbar Tannaz

### Given Name at Birth: Bashir Hassan Zafar

### Genetic Ethnic Classification—Genome Mother Iranian (FF), Father Arab Lebanese (GG)=(FG)

### Cultural Ethnic Classification—Epi-Genome Iranian-Aryan (IAB)

### Blood Type: AB Negative (7)

### Job Classification Medical Doctor Cardiac Surgeon (MZC)

### Current Residence Current Date and Country and City (ICAO) Living (L) 27 Oct. 2010 Iran Tehran (L1027010 OIII)

Juliano Frei Robeval—Brazilian

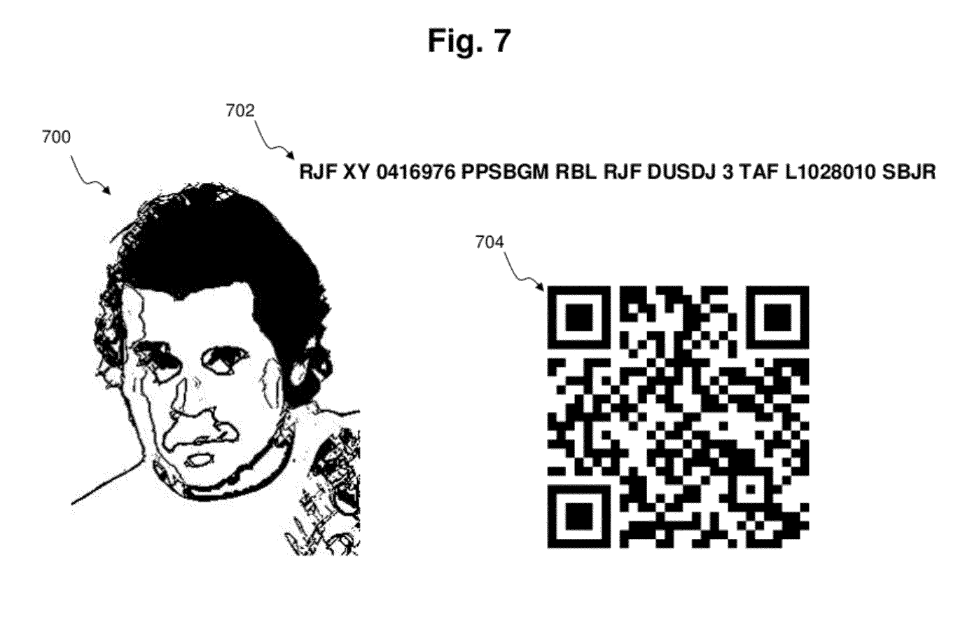

Referring to FIG. 7, the INDI code 702 and associated barcode 704 contain the following information for a Brazilian man 700:

### Name: Juliano Frei Robeval (RJF)

### Sex: Male (XY)

### Date of Birth: 16 Apr. 1976 (0416976)

### Place of Birth: Brazil (PP)

### City of Birth: Guajara-Mirim, Sao Paulo (SBGM)

### Mothers' Maiden Name: Benedita Luisa Renaldo (RBL)

### Given Name at Birth: Juliano Frei Robeval (RJF)

### Genetic Ethnic Classification—Genome Mother Native Indian (DD) Father African of Undetermined Mixed Ancestry (UU)=(DU)

### Cultural Ethnic Classification—Epi-Genome Mother Suva Indian of Brazil (SDJ)

### Blood Type: AB Positive (3)

### Job Classification: Transportation Aviation Flight Attendant (TAF)

### Current Residence Current Date and Country and City (ICAO) Living (L) 28 Oct. 2010 Jacarepagua, Rio de Janeiro, Brazil (SBJR)

Megan Jane Wallace—Australian

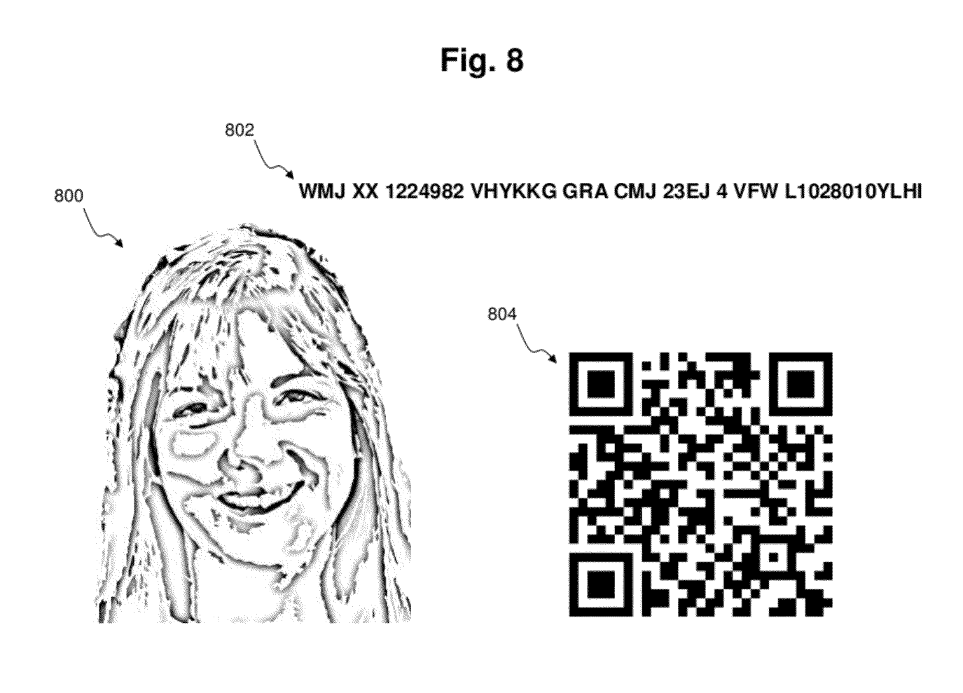

Referring to FIG. 8, the INDI code 802 and associated bar code 804 contain the following information for an Australian woman 800:

### Name: Megan Jane Wallace (WMJ)

### Sex: Female (XX)

### Date of Birth: 24 Dec. 1982 (1224982)

### Country of Birth: Australia (VH)

### City of Birth; Kalkaringi, Northern Territory (YKKG)

### Mothers' Maiden Name: Rosemary Anne Godfrey (GRA)

### Given Name at Birth: Megan Jane Campbell (CMJ)

### Genetic Ethnic Classification—Genome: Mother Anglo-Saxon English Ancestry (22)

### Father Celtic-Scotland (33)=23

### Cultural Ethnic Classification—Epi-Genome Mother English Australian (EJ)

### Blood Type: O Positive (4)

### Job Classification Veterinary Medicine Park Ranger Wild Life (VFW)

### Current Residence Current Date and Country and City (ICAO) Living (L) 28 Oct. 2010 Lord Howe Island, New South Wales (L1028010YLHI)

Gillian Me-Li Petersen—Adopted Chinese-American

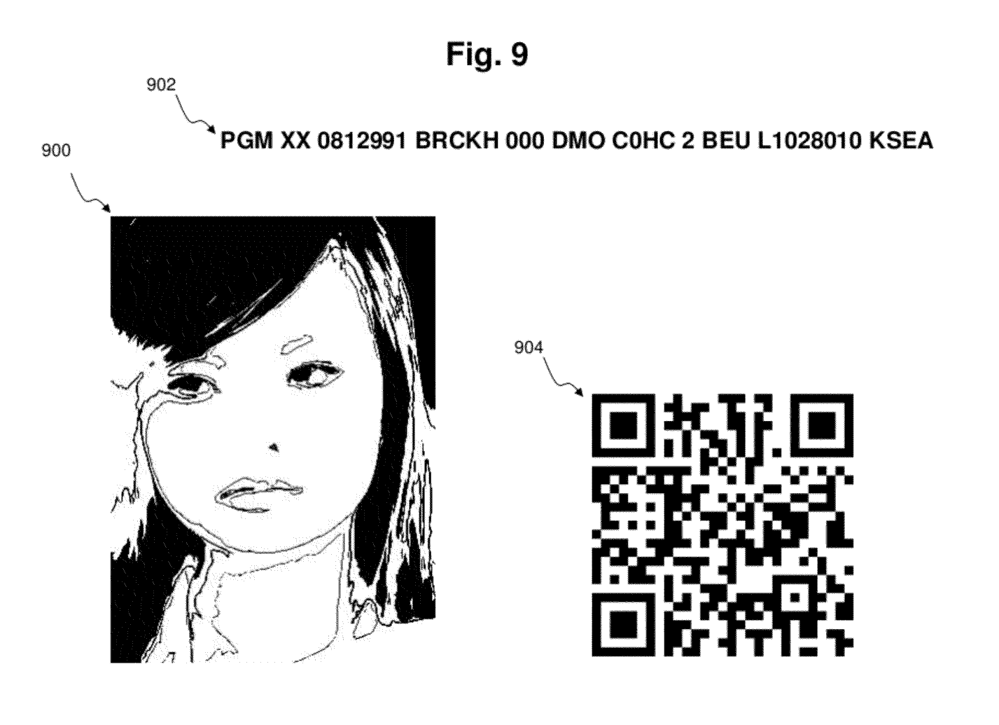

Referring to FIG. 9, the INDI code 902 and barcode 904 contain the following information for an adopted Chinese-American teenage girl:

### Name: Gillian Me-Li Petersen (PGM)

### Sex: Female (XX)

### Date of Birth: 12 Aug. 1991 (0812991)

### Country of Birth: China: (B)

### City of Birth: Kaosiung City (RCKH)

### Mothers' Maiden Name: Name Unknown (0)=(000)

Given Name at Birth: Mei-Li Da-Quan, (by the orphanage) Middle Name Unknown (0)=(DM0)

### Genetic Ethnic Classification—Genome Mother Mainland Chinese (CC)

### Father Unknown (00)=C0

Cultural Ethnic Classification—Epi-Genome Mother Hakka, a distinct subgroup of Han

### Chinese of the People's Republic of China and Taiwan=(HC)

### Blood Type: B Positive (2)

Job Classification University Student studying Banking and Finance (BEU)
Current Residence Current Date and Country and City (ICAO) Living (L) 28 Oct. 2010 Seattle Wash. USA (L1028010) KSEA

Mikhail Serosha Vasiliev—Ukrainian

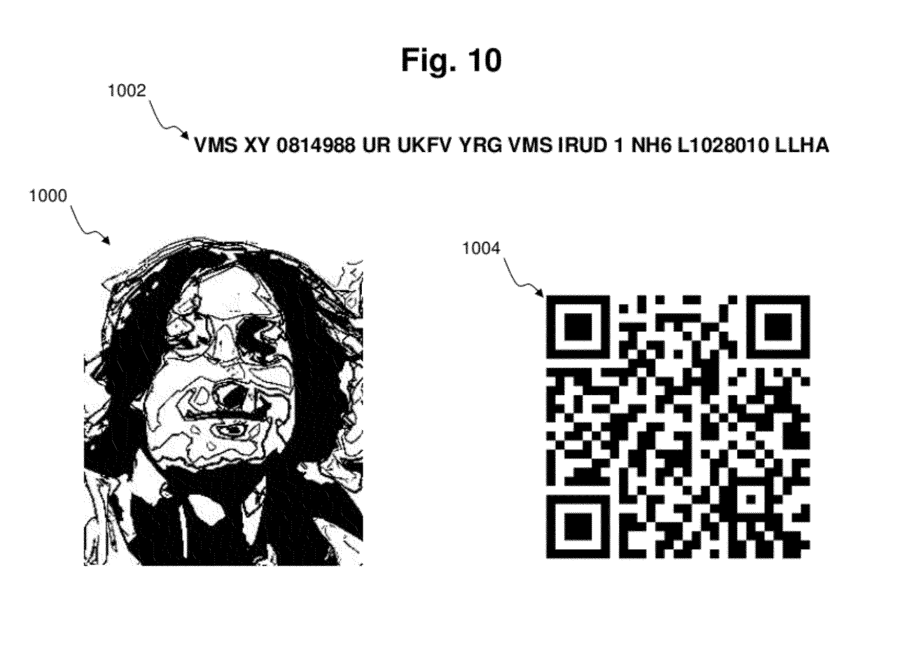

Referring to FIG. 10, the INDI code 1002 and barcode 1004 contain the following information for a Ukrainian male residing in Israel:

### Name: Mikhail Serosha Vasiliev (VMS)

### Sex: Male (XY)

### Date of Birth: 14 Aug. 1988 (0814988)

### Country of Birth: Ukraine (UR)

### City of Birth: Yevpatoriya (UKFV)

### Mothers' Maiden Name: Raisa Galina Yakob (YRG)

### Given Name at Birth: Mikhail Serosha Vasiliev (VMS)

### Genetic Ethnic Classification—Genome Mother Jewish (II), Father Western Russian (RR)=(IR)

### Cultural Ethnic Classification—Epi-Genome Mother Ukrainian (UD)

### Blood Type: A Positive (1)

### Job Classification Engineering Computer Software Programmer (NH6)

### Current Residence Current Date and Country and City (ICAO) Living (L) 28 Oct. 2010 (L1028010) Haifa Israel. (LLHA)

Morgan Elizabeth Stanton—American Child

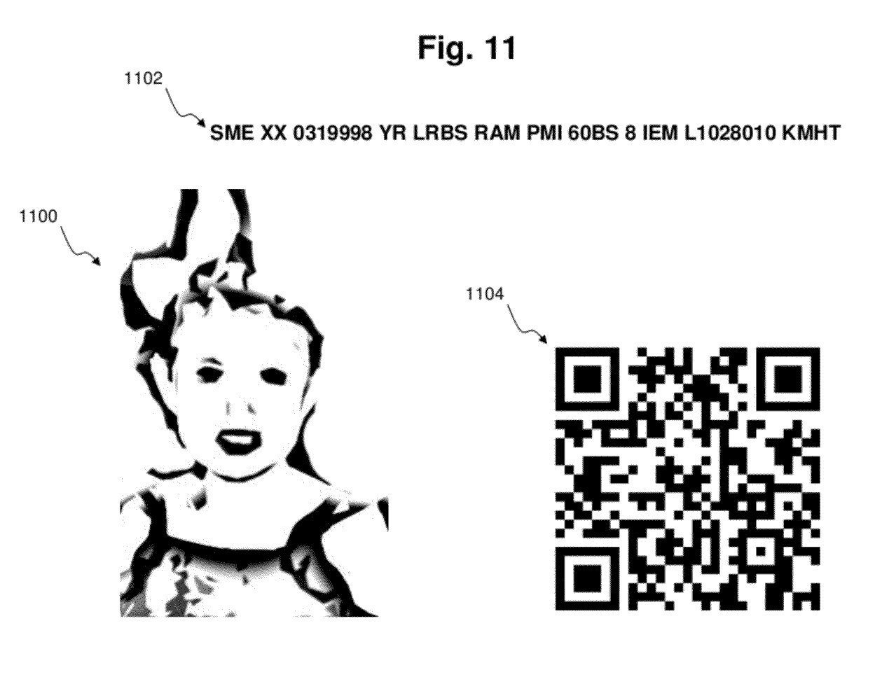

Referring to FIG. 11, the INDI code 1102 and barcode 1104 contain the following information for an American girl:

### Name: Morgan Elizabeth Stanton (SME)

### Sex: Female (XX)

### Date of Birth: 19 Mar. 1998 (0319998)

### Country of Birth: Romania: (YR)

### City of Birth: Bucharest (LRBS)

### Mothers' Maiden Name: Anastasia Madalina Razvan (RAM)

Given Name at Birth: Melita lhrin Pereteanu (PMI)
Genetic Ethnic Classification—Genome Mother Combination of German mother and

### Slavic Father (6S)

### Father Unknown (00)=60

Cultural Ethnic Classification—Epi-Genome Mother Romanian of German origin—Banat Swabian (BS)

### Blood Type: O Negative (8)

### Job Classification Infant Education Middle School Student (IEM)

### Current Residence Current Date and Country and City (ICAO) Living (L) 28 Oct. 2010 Londonderry, N.H. USA (L1028010) KMHT

### D. Exemplary Use of INDI Codes in a Medical Setting

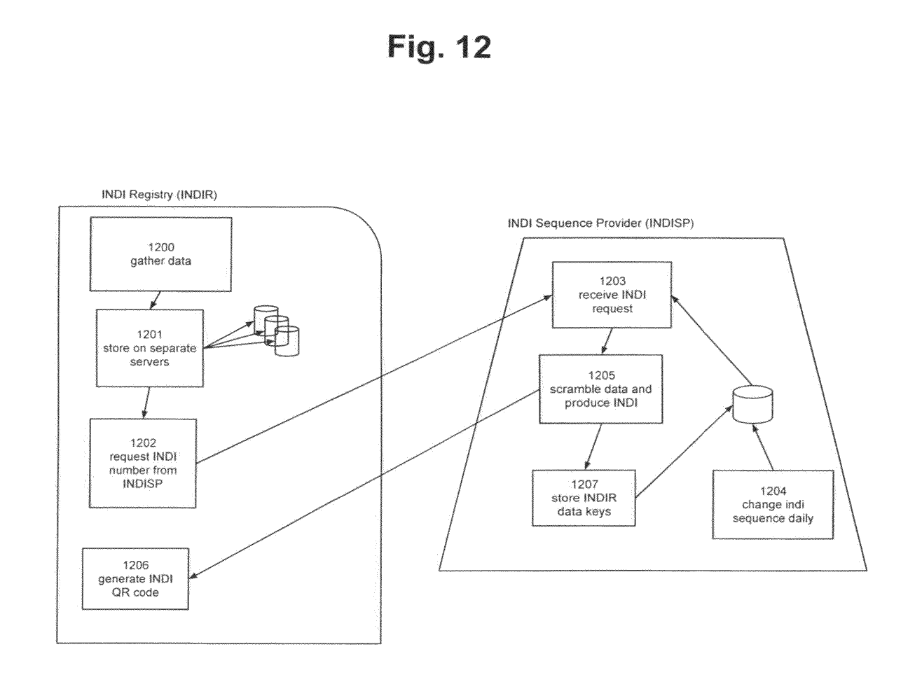

FIGS. 12 through 14 are block diagrams showing an exemplary method for generating, saving, retrieving and reconstructing the INDI code and associated data in a medical setting, according to the invention. The overall exemplary steps of FIGS. 12 through 14 are summarized as follows:

1. A patient gathers his/her individual demographic data and sends the information to an INDISP (INDI Sequence Provider) requesting an INDI code, in effect requesting a unique ID akin to an email address.
2. The INDISP collects the demographic data, and using the unique INDI field code classifications, generates an INDI code, stored in field identifiers with the location of the identifiers within the string scrambled. The scrambling is based on a different sequence provided to the INDISP at a desired time interval, such as on a daily basis. The scrambling is time stamped and also carries an INDISP identifier. As a result, no two individuals can ever have the same INDI code.
3. The INDISP sends back the INDI code in a scrambled form embedded in a QR code, medical card, or other desired format.
4. The INDI code is sent to an INDIR (INDI Registry). The INDISP checks with the INDIR prior to formally issuing an INDI code to verify that it is indeed, unique.
5. The patient goes to a Medical Provider (MP) and supplies the MP with the scrambled QR code, medical card, or other form of code representation.
6. With the patient's authorization, the MP requests the file from the INDIR. The patient has to correctly answer questions to confirm his/her identity. The patient medical file is built from the data in an INDI database and is sent to the Medical Provider for a certain time period.
7. When the file is updated, it is returned to the INDIR. The information in the record is de-identified and sent to the INDI database for storage.
8. The information in the INDI database may be utilized as de-identified medical data containing demographic data such as age, weight, height, sex, ethnicity, DNA, medications, diagnosis, treatments, outcomes, and so on. The de-identified data is never kept in the same set of servers as the INDIR. An attempt to compromise the data stored by the INDIR would result in a string of unsensible alpha numerics. A similar attempt to compromise the INDI database would result in random sets of de-identified medical data, rendering the INDI database both secure and HIPAA compliant. In a medical emergency, the MP may access certain parts of the patient file, necessary to treat the emergency, with the proper prior authorization.
9. The MP may query the INDI database for up to date, real time research information, which will allow for better clinical decision support in the treatment of their specific patient.
10. If an individual's medical record is compromised, a new INDI code is issued with the proper authorization.

1) Generation of the INDI Code

Referring to FIG. 12, in step 1200, an exemplary patient visits a registry web portal to get an INDI code issued based on an identity data set. The portal may be accessed through any suitable or available user interface, including without limitation, a cell phone, smart phone, tablet personal computer, laptop computer, notebook computer, personal computer. The patient is asked for a password, a personal question and an answer. The patient supplies contact information of name, address, telephone number and email address. The patient provides the field data through a series of questions. The patient may also provide insurance information. The patient may further choose to turn on two-step verification and indicate which mobile phone to use for the confirmation code which is supplied via text messaging or a phone call. If the patient chooses not to use two-step verification, the patient is asked to pick a code to enter next time the patient logs in.

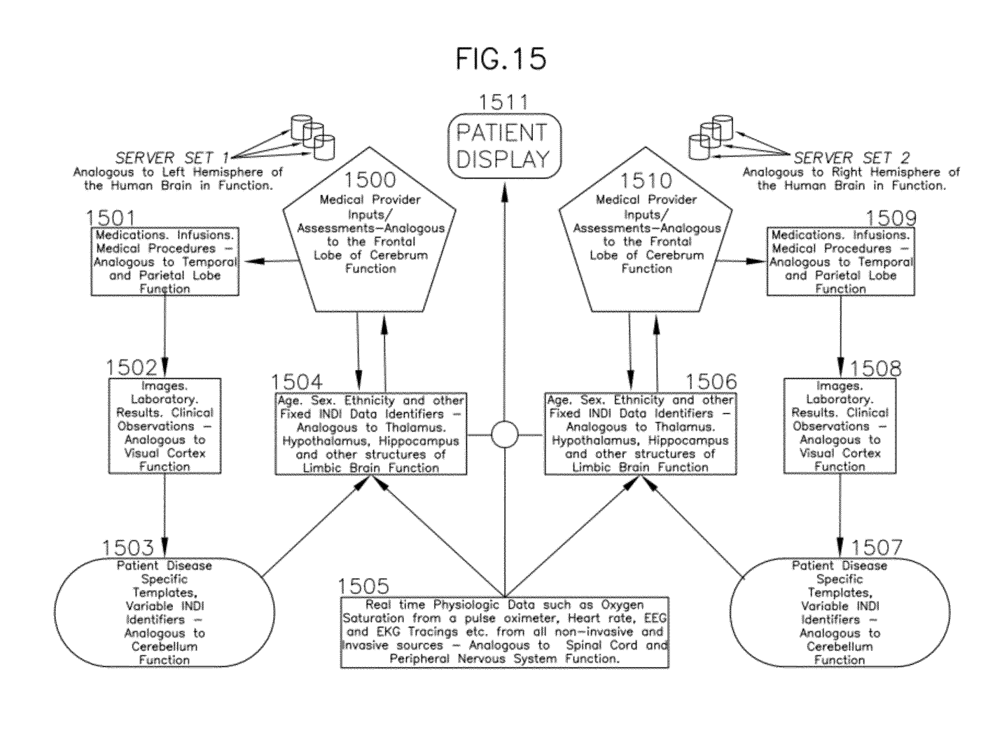

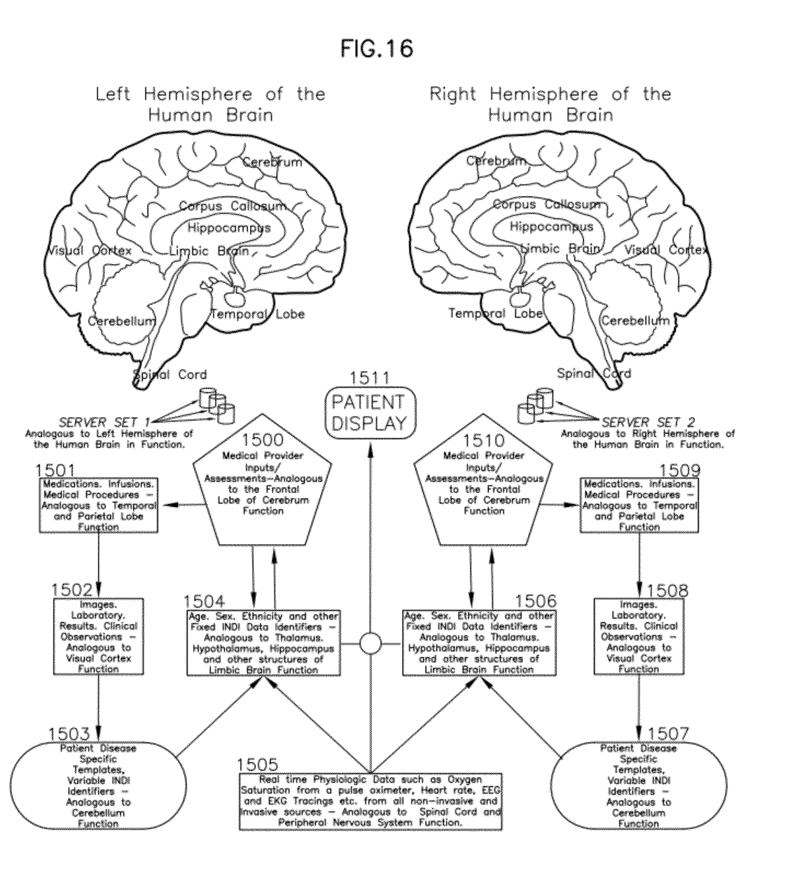

Referring to step 1201, each piece of data is encrypted and scattered across separate servers using a separate internal record id, as further discussed in connection with FIGS. 15 and 16, infra. Each piece of data is associated with a unique data key which includes the server name, type of data, and record id.

Referring to step 1202 of FIG. 12, an INDI Registry (INDIR) sends an encrypted request to an INDI Sequence Provider (INDISP) which contains the field data along with the epoch time stamp, the INDIR data keys, and INDIR code. Each INDIR is assigned a two letter code. Each INDIR is registered with an INDISP. An INDISP can service multiple INDIRs.

Referring to step 1203, the INDISP decrypts the request and looks up the sequence being used for the particular INDIR based on the time stamp. The sequence indicates the position of each sub-section of each piece of field data along with the last five digits of the patient's INDISP internal record id used to store the INDIR data keys.

Referring to step 1204, the sequence is changed every day per the INDIR that is being serviced by the INDISP.

Referring to step 1205, Sections 4, 7, and 8 of the INDI are translated to field codes using the field data received from the INDIR and the resulting data is scrambled and confirmed for uniqueness. An official INDI is returned to the INDIR for display to the patient.

Referring to step 1206, the INDIR generates a QR code and provides a PDF printable card.

Referring to step 1207, the INDISP stores the INDIR data keys in an encrypted database using the record id generated in step 1203.

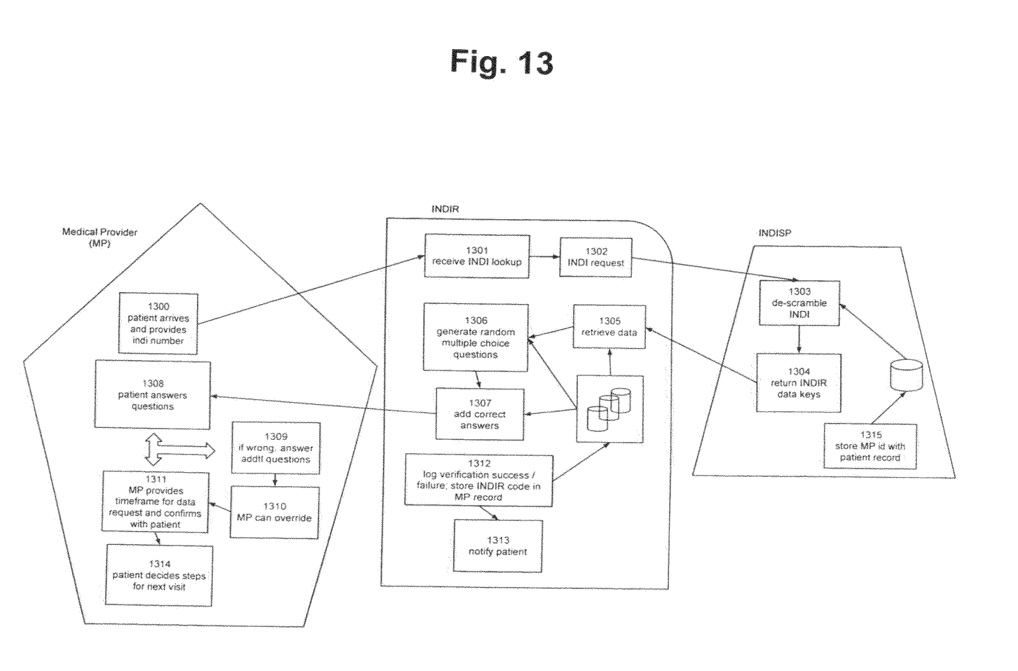

FIG. 13 shows an exemplary method of providing a medical provider (MP) access to electronic medical records for a certain period of time using a patient's INDI code.

Referring to step 1300 of FIG. 13, the patient arrives at the medical provider (MP) as a new patient. The MP pulls up the INDIR online to a look up page specifically provided for MP use. This url is different from the public in that it allows the MP to download the personal information of the patient in a data package that is in a format usable by the MP's particular medical records system (MRS).

Referring to step 1301 of FIG. 13, the patient's INDI QR code is scanned and entered in a look up page. At step 1302, the INDIR sends an encrypted INDI look up request to the INDISP. At step 1303, the INDISP pulls the time stamp and INDIR code from the INDI code and looks up the sequence and de-scrambles the INDI code to determine the internal INDISP record id.

Referring to step 1304 of FIG. 13, the INDISP returns an encrypted response to the INDIR which contains the data keys described in step 1201 of FIG. 12. It should be understood that the data in the INDIR and INDISP are both encrypted to constitute a first level of protection. The INDIR data is also scattered across multiple servers. The only way to know which data belongs to an individual is by using the INDIR data keys which are stored with the INDISP. The INDI is stored at the INDISP in a separate server from the patient data keys. The only way to tie the INDI to the patient data is to de-scramble the INDI to determine the internal INDISP record id which then reveals the INDIR data keys which must then be interpreted and assembled by the INDIR server. Consequently, a number of steps across multiple servers, data systems, security zones, and networks are required to assemble a patient's identity package and associate the patient with their INDI.

Referring to step 1305 of FIG. 13, the INDIR pulls all the field data from the separate servers using the data keys returned by the INDISP.

Referring to step 1306, the INDIR randomly chooses three of the following five INDI code sections: 3-5, 7, and 8 and generates a multiple choice question for each. Each question is pre-populated with nine random answers. The answers are generated in such a way as to make it hard to spot the correct answer. In the case of Date of Birth, dates are chosen that are close to the correct date. In the case of Place of Birth, locations are chosen from the same region and existing INDI data may be used.

Referring to step 1307 of FIG. 13, the INDIR adds the tenth and correct answer for each of the three multiple choice questions and presents the questions to the patient. In step 1308, the patient answers questions to confirm identity.

Referring to step 1309, if the patient answers incorrectly, the patient is prompted to answer the personal question. In step 1310, if verification fails, then it is up to the MP to decide how to proceed. If the patient is unconscious or in a medically verified state of memory loss (they cannot just say: “I don't remember”), the MP can override the verification process.

Referring to step 1311, if verification succeeds, then the MP indicates the requested time frame required for use of the data. The MP may then download to the MP's MRS an encrypted patient identity package with an expiration time and/or date.

Referring to step 1312, the INDIR logs the verification results with the patient's INDIR record and the INDIR code is entered in the MP's record. An MP uses the same INDIR for all patient information requests, but the MP's patients may be registered with several different INDIRs. The MP's INDIR takes care of routing the request to the appropriate INDIR and manages the transaction.

Referring to step 1313, the patient may set up his/her account to be notified by email/text every time a verification log entry is created for their record.

Referring to step 1314, after a patient's INDI has been entered by the MP, the patient may decide, per MP, which steps they want to use for subsequent visits for code verification. In the case where the MP requests an override during a patient's first visit, the patient will be taken through the verification process on the next visit.

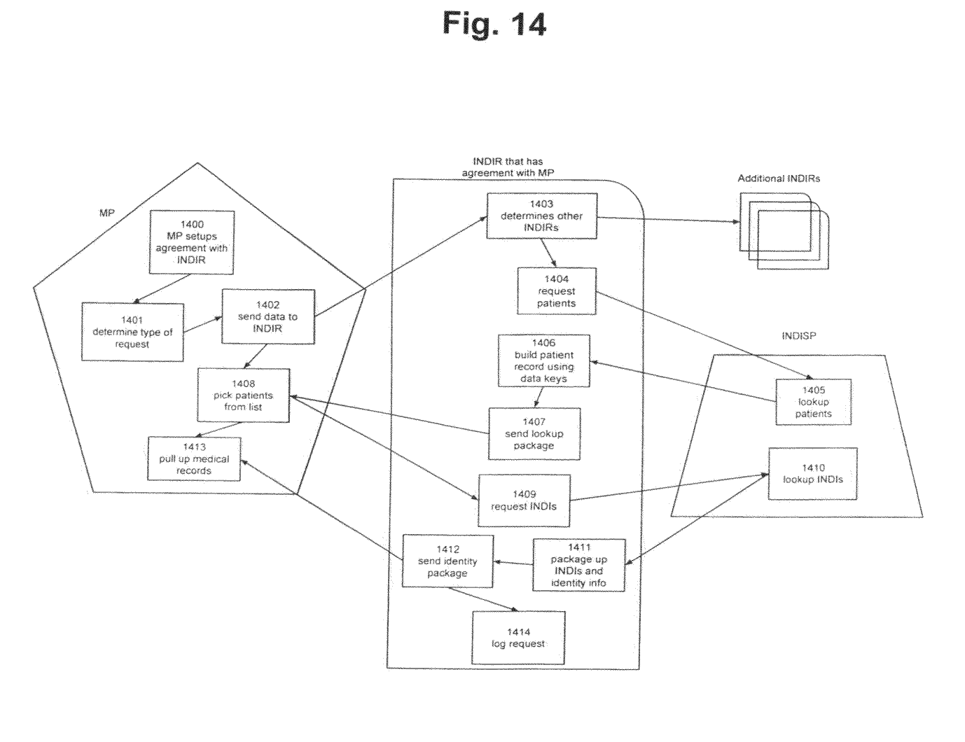

Referring to step 1315 of FIG. 13, the MPs id is stored with the patient's data keys at the INDISP. This facilitates MP query requests as described in section 1400 of FIG. 14, discussed infra.

FIG. 14 is a block diagram showing an exemplary method of data management for MPs and INDIRs that already have agreements in place with the MPs. Referring to step 1400 of FIG. 14, the MP maintains an agreement with the INDIR. The INDIR provides an account and password to the MP when the agreement is established. The agreement includes setting up secured web service communications and defining the format of the data that is exchanged. The MP must agree to de-identify the patient records (a HIPAA statistical standard will be used to determine that protected health information (PHI) is not present in their MRS) and use the INDIR instead to store identifiable information. The MP must implement a time-expired patient data store locally that will be a temporary store of the patient identifiable information which will expire after a set time frame. For example, if a doctor wants to review a patient's file, the doctor issues a request for one hour of access. After the hour has expired, the patient's identity is removed from the MRS and the record is only identifiable by the INDI code.

Referring to step 1401 of FIG. 14, the agreement allows the MP to issue a patient or demographic query request to the INDIR without the patient being present. A demographics query is different in that the full patient identity package is not returned; just the demographic data is returned. This request can be for a longer time frame. The requests may be in the form of a set of INDIs pulled from the MRS based on a query of the MRS medical data. For example, a list of INDIs is generated for all the diabetic patients with glucose levels greater than 50 or all patients with a discharge date within the past 30 days.

Referring to step 1402 of FIG. 14, the query starts with an encrypted request to the INDIR containing the data the MP is looking for.

Referring to step 1403, the INDIR receives the requests and determines which additional INDIRs (using the INDIR codes stored in the MPs record as mentioned in connection with step 1312 of FIG. 13) contain the MPs patient data and sends the request off to the additional INDIRs.

Referring to step 1404 of FIG. 14, each INDIR submits a request to their INDISP for all the MP's patients. In the case where the MP sends a list of INDIs, the request will be limited to those INDIs.

Referring to step 1405, the INDISP looks up all the patients, either by INDI or using the MP's id stored in the patient record, and packages up the patients' data keys and sends an encrypted response back to the INDIR that includes the INDISP internal record id for each patient.

Referring to step 1406, each INDIR builds the patient records using the data keys and runs the query against this data and narrows down the list.

Referring to step 1407, each INDIR sends an encrypted patient identity package back to the MP's INDIR. The MP's INDIR combines the patient records from the additional INDIRs and assembles an identity package of the matching patients in an encrypted response sent back to the MP. This identity package has a very limited time frame and is only used for lookup purposes.

Referring to step 1408, at this point, the patient's medical records cannot yet be accessed. Only the identity information is viewable. The MP may repeat steps 1402-1408 several times to continually refine the list of patients. Once the MP is satisfied with the list of patients, the MP indicates the time frame for the data request and sends that encrypted response back to the INDIR.

Referring to step 1409 of FIG. 14, the MP's INDIR then issues an encrypted request containing the timestamp and internal INDISP record id of the requested patients to each appropriate INDIR. In the case where the MP sends a list of INDIs in the initial request, steps 1409-1411 are not required. Each INDIR sends the request to their INDISP.

Referring to step 1410, the INDISP pulls all the INDIs that match the timestamp and the registry code of the INDIR. The INDISP then de-scrambles the INDI and matches the internal INDISP record id against the INDI and returns the matching INDI. The INDI list is returned in an encrypted response to the INDIR.

Referring to step 1411, the INDIR forwards the response back to the MP's INDIR. The MP's INDIR attaches the INDI codes to the identity information. At step 1412, the INDIR sends an encrypted patient identity package with an expiration date back to the MP. At step 1413, the MP can now use the INDI code to pull up the medical records for each patient in their MRS. At step 1414, each request is logged in the patient's INDIR record. The patient can see which MP issued the request and the time frame for the request.

Steps 1404-1406, 1409-1411, and 1414 may take place at multiple INDIRs and their associated INDISPs.

The patient may update his/her personal information (not including field data, which cannot be altered or else a new INDI must be issued) by logging into the public INDIR portal using their scanned INDI QR code. If a new INDI must be issued, all MPs are notified. To update personal information, steps 1301 through 1308 of FIG. 13 are followed. The patient also will enter his/her password, personal question and answer, and follow a two-step verification process or enter their code.

2) Storage of Additional Data Linked to an INDI Code

FIG. 15 shows an exemplary method of storing electronic medical records data associated with an INDI code. FIG. 15 correlates to Step 1201 of FIG. 12. Modules 1500 and 1510 of FIG. 15 correlate to the MP steps 1300, 1308-1311 and 1314 of FIG. 13.

FIG. 16 shows the left and right brain hemispheres represented (mimicked) by the exemplary method of storing electronic medical records shown in FIG. 15.

Referring to FIG. 15, in general terms, using the field code identifiers of the INDI code, additional data about the individual may be segregated and stored in modules patterned after the structure and function of the human brain. The data is assigned to three primary levels mimicking the evolutionary development of the brain where form follows required function.

Referring to FIGS. 15 and 16, the “Server Set 1” data is generally correlated to portions of the left hemisphere of the human brain. Referring to module 1500 of FIG. 15, the MP inputs and assessments are stored within Server Set 1 at a location akin to the frontal lobe of the human brain's cerebrum. In module 1501, data regarding medications, infusions and medical procedures are stored within Server Set 1 at a location analogous to the temporal and parietal lobes of the human brain. In module 1502, images, laboratory results and clinical observations are stored within Server Set 1 at a location analogous to the visual cortex. In module 1503, patient disease specific templates and the dynamic portions of the INDI code, are stored at a location analogous to the cerebellum. In module 1504, data regarding age, sex, ethnicity and other fixed (unchanging) INDI code fields are stored at a location analogous to the thalamus, hypothalamus, hippocampus and other structures of the limbic brain system.

Referring to FIGS. 15 and 16, the “Server Set 2” data is generally correlated to portions of the right hemisphere of the human brain with duplication for added security.

Referring to FIG. 15, Server Set 1 and Server Set 2 are linked via the limbic system represented by modules 1504 and 1506, as well as shared data from module 1505. Module 1505 represents real time physiologic data such as oxygen saturation from a pulse oximeter, heart rate, EEG and EKG tracings. The data stored at location 1505 is analogous to the spinal cord and the peripheral nervous system.

Referring to FIG. 16, as a result, the data is stored and may be retrieved in a manner analogous to the hierarchy within the human nervous system. The spinal cord and the peripheral nerves (module 1505) can be found in simple organisms such as worms. At the next level of development seen in, for example, reptiles (alligators and snakes), is the added layer of the limbic system (hippocampus, thalamus) represented by modules 1504 and 1506. The top structure of the brain is the cerebrum (modules 1500, 1501) found in primates. The cerebellum coordinates and smoothes out the movement of the organism (modules 1503 and 1507). The input of the doctors (inquiries, treatments for specific conditions and modified responses) are stored on servers analogous to the structures in frontal lobe of the cerebrum or neo-cortex (modules 1500 and 1510). The genetic data (ethnicity) is stored in servers analogous to the thalamus of the limbic system (modules 1504 and 1506). Lab results for the different human body systems (cardiovascular, respiratory, renal, endocrine etc) are stored in servers analogous to the structures of the temporal and parietal lobes (modules 1501, 1509). Images (EKGs, MRIs, Xrays, fMRI, CT's etc) are stored in servers analogous to the visual cortex (modules 1502, 1508).

Diagnostic Data (ICD-9, ICD-10, Kalenderian codes, Snow med CT) is stored in servers analogous to the cerebellum (modules 1503 and 1507). However, the main function of the servers analogous to the cerebellum (modules 1503 and 1507) is the housing of the patient and disease specific templates. Modules 1503 and 1507 are continuously updated with information gathered from the inputs of the health care provider and the outcomes of their prescribed treatments, in terms of whether the patient gets better or worse. These templates only self-adjust when a certain threshold has been reached. This is specific for the patient. The templates are disease specific, but become patient and disease specific upon modification by their doctor.

Referring to FIG. 15, selected data is displayed at step 1511.

Referring to FIG. 16, the entire INDI database is duplicated and interconnected, analogous to the left and right hemispheres of the human brain, which is connected by the corpus callosum at the upper level, and the anterior commissure at the level of the limbic brain.

Separate servers collect and send the incoming physiological, real time data parameters which are collected and separated by the use of the INDI code and send them to both of the duplicated INDI databases. For analysis and treatment of that patient, each module is brought on line and included in the analysis when a certain level of accurate information has reached a given threshold. This mimics the manner in which humans learn to crawl before they can walk or eventually run. Humans learn to walk when the motor cortex comes on line, and the movement is smoothed out by the cerebellum. Humans learn to talk when the Broca area of the temporal lobe comes on line and what we say makes sense when the Wernicke area comes on line. The INDI servers coordinate and modulate the data within the system and appropriate the incoming data with existing data to develop and refine the form and function of each module and coordinate the function as a whole for an integrated system.

It has recently been discovered that the neurons (brain cells) are not randomly distributed in a tangle of fibers, albeit densely packed, but are instead laid out in a grid or lattice structure following a horizontal, vertical and diagonal framework. The design and construction of the INDI database mimics this pattern of connection within and between the datasets. As in the human brain, once a module has sufficient information to provide accurate information, it will be brought on line to effect and modify the function of the growing INDI database.

3) Advanced Integration of INDI Data.

Referring to FIGS. 15 and 16, the end result of the segregation and storage of the data using the INDI code is the formation of several self-contained modules. The different modules pass information between each other and this communication results in the ability to recognize patterns in real time. As new information enters the system, the patterns are further refined until any query is capable of accessing any patient disease specific information. The more data entered utilizing the fields of the INDI code and subsequent inquiries of the MPs will provide real-time updated evidence-based information for the care of the patient. The collective wisdom of doctors' inquiries and responses to treating their patients coupled with the datasets will modify and refine the processing capability of the INDI databases in real-time.

### E. Other Embodiments

It should be understood that various modifications within the scope of this invention can be made by one of ordinary skill in the art without departing from the spirit thereof and without undue experimentation. Significantly, the INDI code is scalable to fewer or more sections, where appropriate, depending on the amount of identity data available or desired. Where limited information is available, the reduced amount of information may be represented by field code sections that are left blank or filled with zeros.

In addition, the use of personalized coded information may be re-ordered, extended and/or simplified. The coded information may be represented by numerals, letters, symbols or a combination thereof; the information may be converted into a bar code; and/or may be represented electronically in any suitable or desired manner.

This invention is therefore to be defined by the scope of the disclosure herein as broadly as the prior art will permit, and in view of the specification if need be, including a full range of current and future equivalents thereof.

### F. Industrial Applicability

It is clear that the inventive International Alpha-Numeric Demographic Identity Code of this application has wide applicability to any individual or industry seeking the maintenance, control and/or use of de-identified data. The present invention provides a unique global identity for every human on the earth, regardless of background or nationality. The apparatus disclosed in this application may be utilized within the health care industry as a global patient identification system to access electronic medical records. The INDI code may further or alternately be used in any desired or suitable commercial or non-commercial setting for identification purposes.

Within the field of medicine, the present invention provides a patient controlled system since only the patient has an intimate knowledge of the information contained in the field codes, and requires their permission and interaction to access their information. It does not utilize artificially generated numbers, such as found in passports, driver's licenses, or state, local, federal, country or internationally issued numbers. The identity data used to form the INDI code is personal to the individual and can be remembered and recalled, at the point of care, for reconstruction and access to data. Patients may initially construct their INDI code based on their personal knowledge of themselves. As an example, they may choose their ethnicity from their maternal parentage based on personal knowledge of that field. However, if and when their mitochondrial DNA becomes available, they will be informed of their specific ethnic origin and can modify their INDI code accordingly.

A health care worker involved in the management of a patient may use the INDI code to access and update a patient's health record. The updated information becomes part of the record and can be accessed, in the future, by other practitioners. Modalities, such as vaccine delivery, specific malaria, anti-TB, or HIV antiretroviral therapies, or the tracking of patients and their outcomes become accessible and fluid across international barriers, institutions and clinics.

I claim:

1. An apparatus for generation and display of a de-identified unique global code for a human comprising:
a registry web portal programmed to display the code comprising a series of field code positions based on a series of field data forming an identity data set for the human;
a sequence provider programmed to assign a unique data key, encrypt and segregate each of the field data across a plurality of servers;
wherein the registry is programmed to send an encrypted request to the sequence provider, said request comprising at least one of the field data;
wherein the sequence provider is programmed to decrypt the request and determine a field code position for each of the field data;
wherein the sequence provider translates and assigns the field data to the field code positions; and,
wherein the sequence provider provides the registry with the code for the display.

2. The apparatus of claim 1, wherein the identity data set is obtained through a user interface comprising a device selected from the group consisting of: cell phone, smart phone, tablet personal computer, laptop computer, notebook computer, personal computer.

3. The apparatus of claim 1, wherein the identity data set comprises: a current name, a sexual identity, a date of birth, a country of birth, a place of birth, a maiden name of a birth mother, a name at birth, an ethnic classification, a tribal classification, a blood type, an occupation, a country of residence, a location of residence.

4. The apparatus of claim 1, wherein the identity data set comprises data regarding a country and place of birth for the human, a coded representation of said data comprising International Civil Aviation Organization codes.

5. The apparatus of claim 1, wherein the identity data set comprises a set of static data about the human combined with a set of dynamic data about the human.

6. The apparatus of claim 1, wherein the de-identified global code contains a set of static field codes and a set of dynamic field codes.

7. The apparatus of claim 1, wherein the de-identified global code is modified during a life time of the human to reflect a set of changing conditions for the human.

8. The apparatus of claim 1, wherein a portion of the identity data set is translated to a set of residence coordinates comprising a latitudinal coordinate, on the one hand, and a longitudinal coordinate, on the other hand, said residence coordinates compared to a set of airport center coordinates for a determination of an airport center coordinate in closest proximity to the residence coordinates and assignment of a corresponding International Civil Aviation Organization code closest to the residence coordinates.

9. The apparatus of claim 1, wherein a portion of the identity data set is translated to an ethnic classification for the human comprising a first letter from an ethnic classification of a mother of the human, and a second letter from an ethnic classification of a father of the human.

10. The apparatus of claim 1, wherein a portion of the identity data set is translated to an ethnic classification for the human comprising a representation of the human's haplo genetics/mitochondrial maternal DNA.

11. The apparatus of claim 1, wherein a portion of the identity data set is translated to an ethnic classification for the human comprising a representation of the human's Y chromosomal haplo DNA line.

12. The apparatus of claim 1, wherein a portion of the identity data set is translated to a tribal classification comprising a representation of a cultural background for the human as linked to a location of an upbringing of the human.

13. The apparatus of claim 1, wherein the plurality of servers further comprise a storage of additional data regarding the human segregated according to the code in a plurality of modules patterned after a structure and a function of a human neurological system.

14. The apparatus of claim 1, wherein the plurality of servers further comprise a storage of electronic medical records regarding the human segregated according to the code in a plurality of modules in operative communication analogous to a left hemisphere and a right hemisphere of a human brain.

15. The apparatus of claim 1, wherein the plurality of servers further comprise a storage of a set of electronic medical records and a set of real-time physiological data for the human segregated according to the code in a plurality of modules, and wherein the modules are accessed for an analysis of a health condition for the human upon an amount of data within the modules reaching a specified threshold.

16. The apparatus of claim 1, wherein the display of the code is selected from the group consisting of: an alpha-numeric string, a QR code, a medical card.

17. A computer implemented method of generating and displaying a de-identified unique global code for a human, comprising the operations of:
providing a registry web portal programmed to display the code comprising a series of field code positions based on a series of field data forming an identity data set for the human;
providing a sequence provider programmed to assign a unique data key, encrypt, and segregate the field data across a plurality of servers;
the registry sending an encrypted request to the sequence provider, said request comprising at least one of the field data;
the sequence provider decrypting the request and determining a field code position for each of the field data;
the sequence provider translating and assigning the field data to the field code positions; and,
the sequence provider providing the registry with the code for the display.

18. The method of claim 17, wherein the de-identified global code contains a set of static field codes and a set of dynamic field codes.

19. A non-transitory computer readable storage media containing a program to generate and display a de-identified unique global code for a human, the operations comprising:
providing a registry web portal programmed to display the code comprising a series of field code positions based on a series of field data forming an identity data set for the human;
providing a sequence provider programmed to assign a unique data key, encrypt and segregate the field data across a plurality of servers;
the registry sending an encrypted request to the sequence provider, said request comprising at least one of the field data;
the sequence provider decrypting the request and determining a field code position for each of the field data;
the sequence provider translating and assigning the field data to the field code positions; and,
the sequence provider providing the registry with the code for the display.

20. The method of claim 19, wherein the de-identified global code contains a set of static field codes and a set of dynamic field codes.
